(19) United States
(12) Patent Application Publication
(10) Pub. No.: US 2026/0186436 A1
(43) Pub. Date: Jul. 2, 2026

(54) FIXING DEVICE AND IMAGE FORMING APPARATUS

(71) Applicant: FUJIFILM Business Innovation Corp., Tokyo (JP)

(72) Inventors: Keitaro MORI, Kanagawa (JP); Toshiyuki Miyata, Kanagawa (JP); Ayuka Nasu, Kanagawa (JP); Ryota Hidaka, Kanagawa (JP)

(73) Assignee: FUJIFILM Business Innovation Corp., Tokyo (JP)

(21) Appl. No.: 19/303,718

(22) Filed: Aug. 19, 2025

(30) Foreign Application Priority Data
Dec. 27, 2024 (JP) 2024-232975

(51) Int. Cl. G03G 15/20

(52) U.S. Cl. CPC G03G 15/2053; G03G 15/2064; G03G 2215/2025

(57) ABSTRACT

A fixing device includes a heating member that includes a tube member that is cylindrical, extends in an axial direction, rotates, and has an internal circumferential surface to which grease is applied, and a heat generator that extends in the axial direction, that is in contact with the internal circumferential surface, and that generates heat to heat the tube member; and a pressing member that is disposed to face the heat generator with the tube member interposed therebetween, that forms a nip portion to hold a recording medium between the pressing member and the heating member, and presses the recording medium against the heating member, in which the heating member and the pressing member are disposed while allowing the internal circumferential surface and a member disposed inside the tube member to be in no contact with each other at at least one of portions upstream and downstream of the nip portion in a rotation direction of the tube member.

### Cross-Reference to Related Applications

This application is based on and claims priority under 35 USC 119 from Japanese Patent Application No. 2024-232975 filed December 27, 2024.

### Background

### (i) Technical Field

The present disclosure relates to a fixing device and an image forming apparatus.

### (ii) Related Art

A fixing device described in Japanese Unexamined Patent Application Publication No. 2015-166796 includes a heating body, a fixing rotator heated by the heating body, a guide member that guides the fixing rotator and that is enclosed in the fixing rotator, grease interposed between the fixing rotator and the guide member, a pressing member that comes into pressure contact with the guide member with the fixing rotator interposed therebetween to form a nip portion, and a driving member that rotates the pressing member forward and rearward. When the fixing device rotates the pressing member forward, a predetermined gap is left between the fixing rotator and the guide member at a portion downstream from the guide member in a sheet feeding direction. When the fixing device rotates the pressing member rearward, a gap that is left is smaller than the gap left during the forward rotation, and rearward rotation driving is performed at an interval depending on the number of recording media that have undergone a fixing process.

### Summary

Aspects of non-limiting embodiments of the present disclosure relate to a fixing device in an image forming apparatus. The fixing device includes a heating member that heats a toner image formed on a recording medium, and a pressing member that presses the recording medium against the heating member. The heating member includes a cylindrical tube member that rotates, and a heat generator that heats the tube member by generating heat while being in contact with an internal circumferential surface of the tube member. A nip portion that holds a recording medium is formed between the heating member and the pressing member.

The heat generator is disposed to face the pressing member with the tube member interposed therebetween, and a recording medium held at the nip portion is heated by the heat generator with the tube member interposed therebetween. Grease is applied to the internal circumferential surface of the tube member to reduce a frictional force between the internal circumferential surface of the tube member and the heat generator at the nip portion.

However, at portions upstream and downstream from the nip portion in a rotation direction of the tube member, the internal circumferential surface of the tube member and a member disposed inside the tube member may come into contact with each other. When the grease is held at the portion where the internal circumferential surface and the above member come into contact with each other, the grease accumulates at this portion, and the amount of grease fed between the heat generator and the tube member is reduced.

The present disclosure aims to further reduce a frictional force caused between the internal circumferential surface of the tube member and the heat generator compared to that caused when the internal circumferential surface of the tube member and a member disposed inside the tube member are in contact with each other at portions upstream and downstream of the nip portion in the rotation direction of the tube member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a heating member that includes a tube member that is cylindrical, extends in an axial direction, rotates, and has an internal circumferential surface to which grease is applied, and a heat generator that extends in the axial direction, that is in contact with the internal circumferential surface, and that generates heat to heat the tube member; and a pressing member that is disposed to face the heat generator with the tube member interposed therebetween, that forms a nip portion to hold a recording medium between the pressing member and the heating member, and presses the recording medium against the heating member. The heating member and the pressing member are disposed while allowing the internal circumferential surface and a member disposed inside the tube member to be in no contact with each other at at least one of portions upstream and downstream of the nip portion in a rotation direction of the tube member.

### Brief Description of the Drawings

Exemplary embodiments of the present disclosure will be described in detail based on the following figures, wherein:

FIG. 1 is a schematic diagram of an image forming apparatus according to an embodiment of the present disclosure;

FIG. 2 is a schematic diagram of an image forming unit included in an image forming apparatus according to an embodiment of the present disclosure;

FIG. 3 is a diagram of the entirety of a fixing device according to an embodiment of the present disclosure;

FIG. 4 is a plan view of components including a heater, included in a fixing device according to an embodiment of the present disclosure;

FIG. 5 is an enlarged view of a nip portion in a fixing device according to an embodiment of the present disclosure; and

FIG. 6 is a diagram of the entirety of a fixing device according to a comparative example for an embodiment of the present disclosure.

### Detailed Description

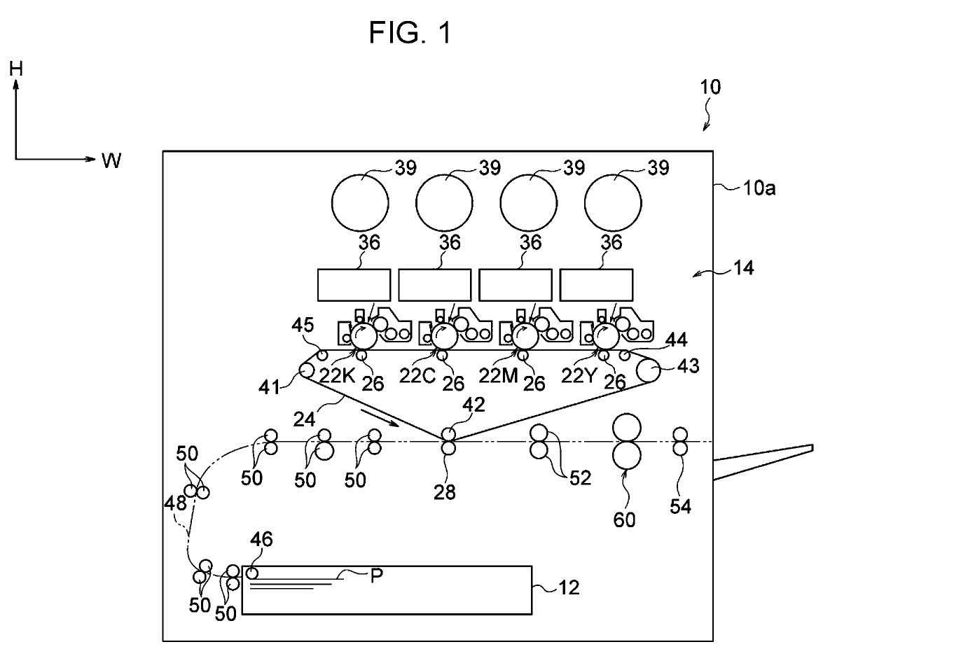

With reference to FIG. 1 to FIG. 6, examples of a fixing device and an image forming apparatus according to an exemplary embodiment of the present disclosure are described. Throughout the drawings, arrow H indicates a perpendicular direction, and a vertical direction of the device or the apparatus. Arrow W is orthogonal to arrow H and horizontal, and indicates a width direction of the device or the apparatus. Arrow D is orthogonal to arrow H and arrow W and horizontal, and indicates a depth direction of the device or the apparatus.

### ENTIRE STRUCTURE OF IMAGE FORMING APPARATUS

As illustrated in FIG. 1, an image forming apparatus 10 includes a housing 10a that accommodates components inside. The image forming apparatus 10 further includes, in the housing 10a, a container 12 that accommodates sheet-shaped recording media P, and an image forming portion 14 that forms images on the recording media P. The image forming apparatus 10 further includes, in the housing 10a, a transport portion 16 that transports the recording media P from the container 12 to the image forming portion 14.

Image Forming Portion 14

As illustrated in FIG. 1, the image forming portion 14 includes image forming units 22Y, 22M, 22C, and 22K (hereafter “22Y to 22K”) to form toner images of respective colors including yellow (Y), magenta (M), cyan (C), and black (K). In the description below, Y, M, C, and K appended to the reference signs are omitted when the colors of yellow, magenta, cyan, and black are not to be particularly distinguished from one another.

The image forming portion 14 further includes an intermediate transfer belt 24 to which toner images formed by the image forming units 22 for the respective colors are transferred. The image forming portion 14 further includes first transfer rollers 26 that transfer toner images formed by the image forming units 22 for the respective colors to the intermediate transfer belt 24. The image forming portion 14 further includes a second transfer roller 28 that transfers the toner images transferred to the intermediate transfer belt 24 by the first transfer rollers 26 to the recording media P.

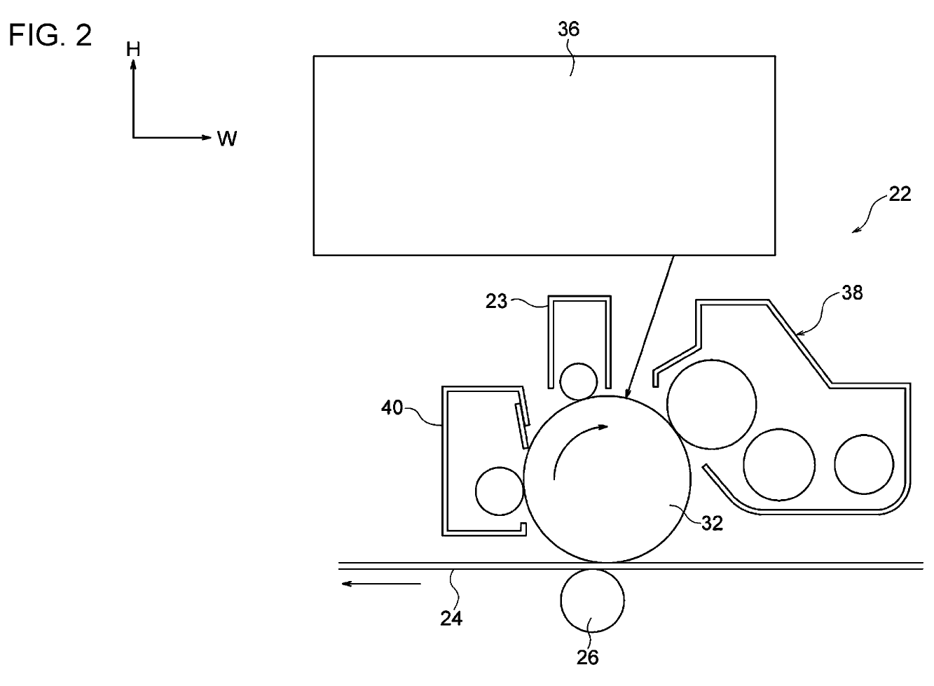

The image forming units 22 for the respective colors are disposed above the intermediate transfer belt 24, and arranged side by side in the width direction. As illustrated in FIG. 2, the image forming units 22 each include an image carrier 32 that rotates in an arrow direction in the drawing.

Around the image carrier 32, a charging device 23, a light exposure device 36, a development device 38, and a removal device 40 are disposed in order from upstream in a rotation direction of the image carrier 32. The charging device 23 charges the image carrier 32 with electricity, and the light exposure device 36 exposes the electrically charged image carrier 32 to light to form an electrostatic latent image on the image carrier 32. The development device 38 further develops the electrostatic latent image formed on the image carrier 32 to form a toner image. The removal device 40 comes into contact with the image carrier 32 to remove toner remaining on the image carrier 32. As illustrated in FIG. 1, above the light exposure devices 36 for the respective colors, toner containers 39 for the respective colors that accommodate toner to be fed to the respective development devices 38 are disposed.

The intermediate transfer belt 24 is disposed in a triangular form having a vertex located at the bottom. On the internal periphery of the intermediate transfer belt 24, winding rollers 41, 42, 43, 44, and 45 around which the intermediate transfer belt 24 is wound are disposed. For example, with a rotation of the winding roller 43, the intermediate transfer belt 24 circularly moves (rotates) in a single direction (for example, a counterclockwise direction in FIG. 1) while being in contact with the image carriers 32.

The first transfer rollers 26 for the respective colors are disposed to face the image carriers 32 with the intermediate transfer belt 24 interposed therebetween. A portion between each of the first transfer rollers 26 and a corresponding one of the image carriers 32 serves as a first transfer position at which the toner image formed on the image carrier 32 is transferred to the intermediate transfer belt 24.

The second transfer roller 28 is disposed to face the winding roller 42 with the intermediate transfer belt 24 interposed therebetween. A portion between the second transfer roller 28 and the winding roller 42 serves as a second transfer position at which the toner images transferred to the intermediate transfer belt 24 are transferred to the recording medium P.

The transport portion 16 includes a pick-up roller 46 that feeds the recording media P accommodated in the container 12 to a transport path 48. The transport portion 16 further includes multiple transport rollers 50 that transport the recording media P to the second transfer position along the transport path 48.

The transport portion 16 further includes transport rollers 52 that transport, along the transport path 48, the recording media P to which toner images have been transferred at the second transfer position. The transport portion 16 further includes discharge rollers 54 that discharge the transported recording media P from the housing 10a. A fixing device 60 is disposed on the transport path 48 between the transport rollers 52 and the discharge rollers 54. The fixing device 60 is described in detail later.

### OPERATION OF IMAGE FORMING APPARATUS

An operation of the image forming apparatus 10 is described now. More specifically, an image forming operation to form images on the recording media P is described.

In the image forming apparatus 10 illustrated in FIG. 1, the recording media P picked up by the pick-up roller 46 from the container 12 are fed to the second transfer position by the multiple transport rollers 50.

In each image forming unit 22 for the corresponding color, the image carrier 32 electrically charged by the charging device 23 illustrated in FIG. 2 is exposed to light by the light exposure device 36 to have an electrostatic latent image formed thereon. The electrostatic latent image is then developed by the development device 38 into a toner image formed on the image carrier 32.

The toner images of the respective colors formed by the image forming units 22 for the respective colors are superposed one on another on the intermediate transfer belt 24 by the first transfer rollers 26 for the respective colors at the first transfer positions to form a color image. The color image formed on the intermediate transfer belt 24 illustrated in FIG. 1 is then transferred by the second transfer roller 28 to each of the recording media P transported by the transport rollers 50.

The recording medium P to which the toner image is transferred is then transported to the fixing device 60 by the transport rollers 52, and the transferred toner image is fixed by the fixing device 60. The recording medium P to which the toner image is fixed is discharged out of the housing 10a by the discharge rollers 54.

### STRUCTURE OF RELATED PORTION

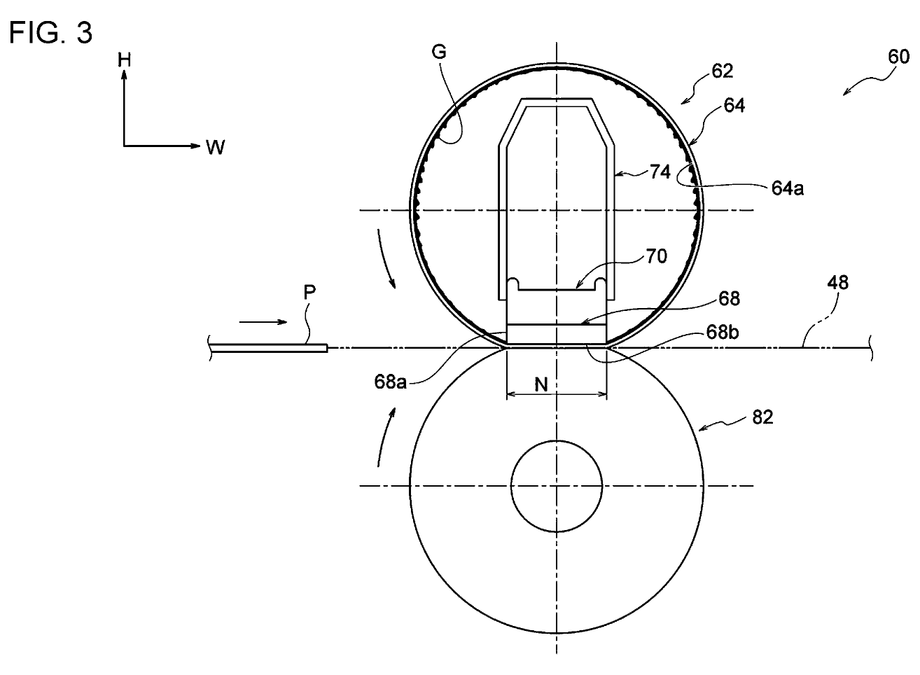

The fixing device 60 according to the present embodiment is then described. As illustrated in FIG. 3, the fixing device 60 includes a heating member 62 that heats the recording media P, and a pressing member 82 that presses the recording media P against the heating member 62. More specifically, the heating member 62 and the pressing member 82 face each other in the vertical direction, and the heating member 62 is disposed above the pressing member 82.

Heating Member 62

As illustrated in FIG. 3, the heating member 62 includes a cylindrical fixing belt 64 and a heater 68 disposed inside the fixing belt 64. The heater 68 receives an applied voltage to generate heat, and to then heat the fixing belt 64. The heating member 62 further includes a support pad 70 that supports the heater 68, and a support frame 74 that supports the support pad 70. The fixing belt 64 is an example of a tube member. The heater 68 is an example of a heat generator.

Fixing Belt 64 and Heater 68

As illustrated in FIG. 3, the fixing belt 64 is a cylindrical, extends in the depth direction, and rotates in the counterclockwise direction while an internal circumferential surface 64a is in contact with the heater 68. The depth direction is an example of the axial direction.

Grease G is applied to the internal circumferential surface 64a of the fixing belt 64. In the present embodiment, for example, the grease G has a worked penetration value, defined by JIS K 2220, of lower than or equal to 250. More specifically, the grease G applied to the internal circumferential surface 64a of the fixing belt 64 is harder than grease G with a worked penetration value of higher than 250. The viscosity of the grease G at 200℃ measured with a rheometer is within 50 to 1500 Pa∙s, preferably, 80 to 1000 Pa∙s, or more preferably, 100 to 500 Pa∙s. When stored while being heated at 230℃ for 336 hours, the grease G has a weight reduction rate of 0 to 20 wt%, preferably, 0 to 15 wt%, or more preferably, 0 to 10 wt%.

The grease G is formed from a combination of base oil and a thickener. Preferably, the base oil in the grease G is silicone oil, for example, dimethyl silicone oil, methylphenyl silicone oil, or diphenyl silicone oil, and may partially have side chains introduced. A weight-average molecular weight Mw of the silicone oil is 10000 to 100000, preferably, 10000 to 60000, or more preferably, 15000 to 40000.

One or more components of the thickener in the grease G are selected from among inorganic materials including, for example, melamine cyanurate, boron nitride, carbon black, silica, graphite, molybdenum disulfide, zinc stearate, and tungsten disulfide. An average particle diameter (D50v) of the thickener is 0.01 to 15 μm, preferably, 0.1 to 10 μm, or more preferably, 0.1 to 5 μm. The weight ratio of the base oil in the component of the grease G is 40 to 95 wt%, preferably, 50 to 85 wt%, or more preferably, 50 to 75 wt%.

The viscosity of the grease G is measured in the following manner. A grease sample is held between parallel plates with a diameter of 40 mm, heated at a gap of 1 mm, at an angular velocity of 0.1 rad/s, and at a speed of 6℃/min from 40℃ to 200℃ using a dynamic viscoelasticity measurement device (rheometer ARES-G2 from TA Instruments) to undergo viscosity measurement.

The weight reduction rate of the grease G is obtained by extracting 5 g of the grease sample into an aluminum cup, heating the extracted sample with an oven at 230℃ for 336 hours, and performing calculation based on the weight obtained before or after the heating.

The average particle diameter of the thickener is measured in the method described below. Onto filter paper, 2 g of the grease sample is extracted, 30 g of tetrahydrofuran (THF) is added to the extracted grease sample, and the resultant undergoes suction filtration to separate the base oil and the thickener from each other. The separated thickener is dispersed in water, and the particle size distribution is measured by a particle size distribution measurement device (LS13320 from Beckman Coulter, Inc.).

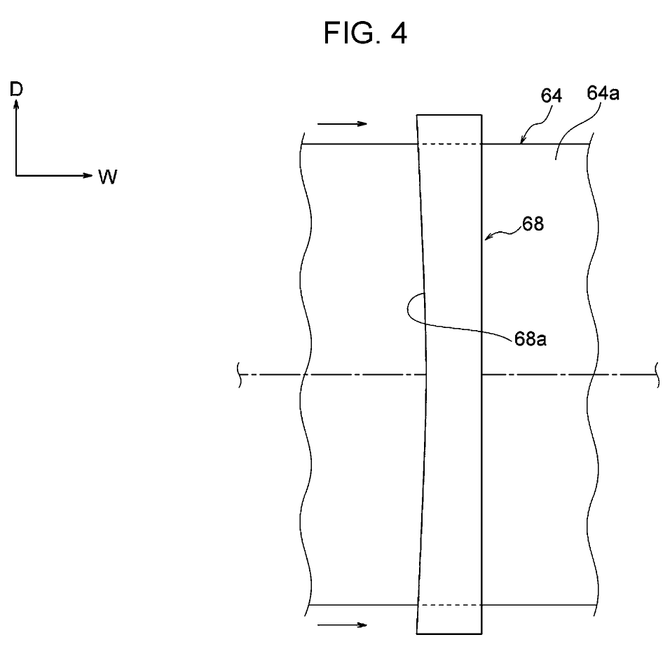

The heater 68 is a so-called flat heater having, when viewed in the depth direction, a rectangular shape extending in the width direction along the transport path 48, and extends in the depth direction. The heater 68 is in contact with the internal circumferential surface 64a of the fixing belt 64 at a contact surface 68b. An edge 68a of the heater 68 upstream in the rotation direction of the fixing belt 64 is open to the internal space of the fixing belt 64. As illustrated in FIG. 4, a center portion of the upstream edge 68a in the depth direction is recessed further downstream in the rotation direction of the fixing belt 64 compared to both end portions in the depth direction.

When viewed in the depth direction, a portion of the fixing belt 64 that comes into contact with the heater 68 is rectilinear and extends along the transport path 48. When a voltage is applied, the heater 68 generates heat over the entire area that is in contact with the fixing belt 64 to heat the fixing belt 64.

Support Pad 70 and Support Frame 74

The support pad 70 is formed from a resin material, and, as illustrated in FIG. 3, disposed to face a portion of the fixing belt 64 that comes into contact with the heater 68 with the heater 68 interposed therebetween. In addition, the length of the support pad 70 in the width direction is the same as the length of the heater 68 in the width direction, and the support pad 70 overlaps the heater 68. The support pad 70 supports the heater 68 throughout in the depth direction.

The support frame 74 is formed by bending a metal plate, and has, when viewed in the depth direction, a U-shaped cross section with an opening facing the support pad 70. The support frame 74 supports the support pad 70 by holding the support pad 70 with both end portions in the width direction. This support frame 74 extends in the depth direction, and supports the support pad 70 throughout in the depth direction. Both end portions of the support frame 74 in the depth direction protrude from the fixing belt 64, and are supported by frame members, not illustrated.

Pressing Member 82

The pressing member 82 has a roller shape, and as illustrated in FIG. 3, is disposed to face the heating member 62 with the transport path 48 interposed therebetween. The pressing member 82 and the heater 68 hold the fixing belt 64 therebetween.

In this structure, the pressing member 82 rotates in the arrow direction (clockwise direction) with a driving force transmitted from a motor not illustrated. The fixing belt 64 is driven to rotate in the arrow direction (counterclockwise direction) by the rotation of the pressing member 82.

The pressing member 82 forms a nip portion N at which the pressing member 82 and the heating member 62 hold each recording medium P therebetween, and presses the recording medium P against the heating member 62 at the nip portion N. The heating member 62 and the pressing member 82 are disposed while allowing the internal circumferential surface 64a and a member disposed inside the fixing belt 64 to be in no contact with each other at portions upstream and downstream of the nip portion N in the rotation direction of the fixing belt 64 (hereafter referred to as “belt rotation direction”).

As described above, the nip portion N is a portion where the pressing member 82 presses each recording medium P against the heating member 62. The range of the nip portion N may be identified by placing a surface pressure measurement sheet between the heating member 62 and the pressing member 82. The nip portion N is an area that bears pressure in the measurement using the surface pressure measurement sheet.

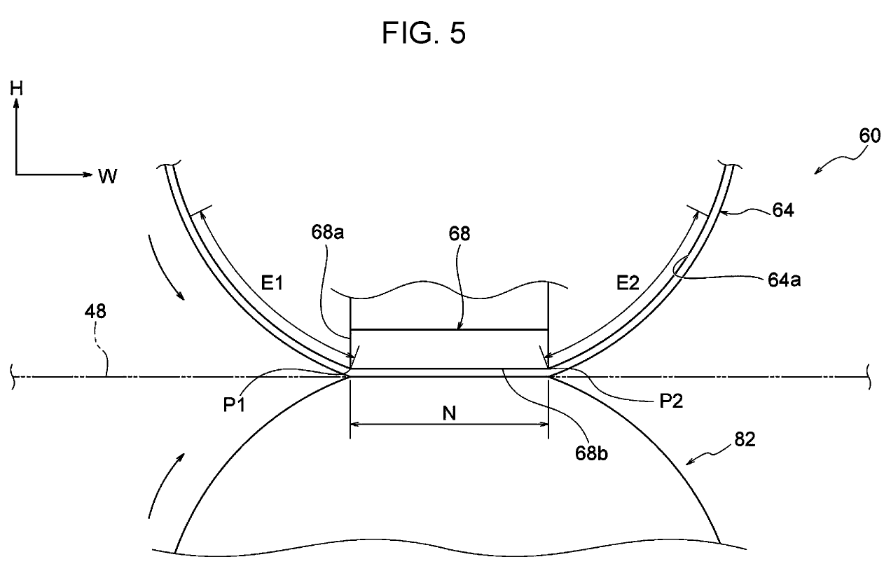

The length of the nip portion N in the belt rotation direction is denoted with L1. As illustrated in FIG. 5, a portion upstream of the nip portion in the belt rotation direction corresponds to a range E1 with a length L1 and located upstream in the belt rotation direction from an upstream end P1 of the nip portion N in the belt rotation direction. A portion downstream of the nip portion in the belt rotation direction corresponds to a range E2 with the length L1 and located downstream in the belt rotation direction from a downstream end P2 of the nip portion N in the belt rotation direction.

### OPERATIONS OF RELATED PORTIONS

Operations of the fixing device 60 are described, together with a fixing device 160 according to a comparative example. First, the structure of the fixing device 160 according to a comparative example is described in terms of, for example, points different from those in the fixing device 60 according to the present embodiment.

Structure of Fixing Device 160

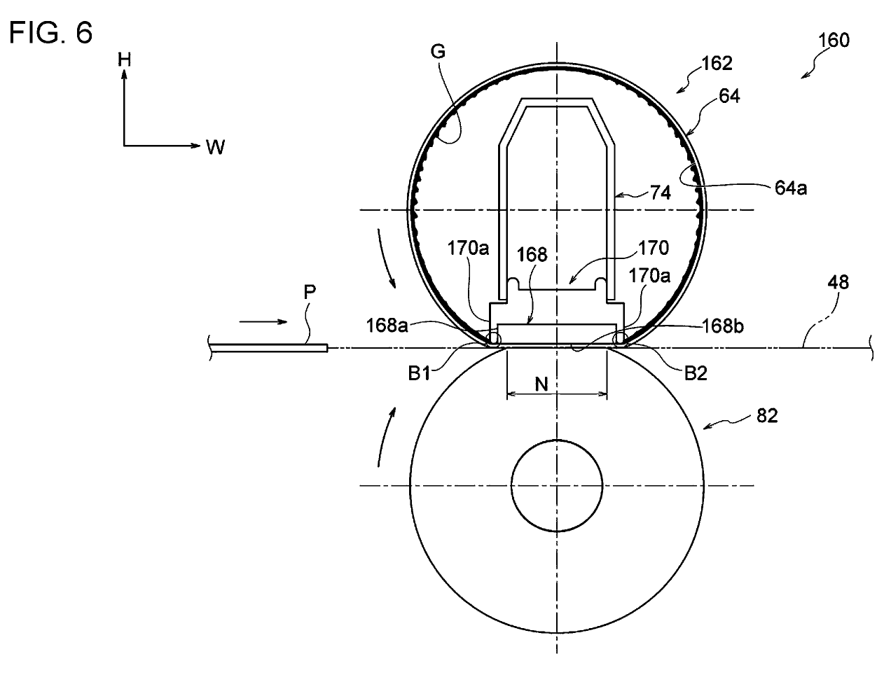

As illustrated in FIG. 6, the fixing device 160 includes a heating member 162 and a pressing member 82. The heating member 162 includes a cylindrical fixing belt 64, a heater 168, a support pad 170, and a support frame 74.

The heater 168 has a rectangular shape extending in the width direction when viewed in the depth direction, and extends in the depth direction. The heater 168 is in contact with the internal circumferential surface 64a of the fixing belt 64 at a contact surface 168b. An upstream edge 168a of the heater 168 in the belt rotation direction extends in the depth direction. The dimension of the heater 168 in the width direction is longer than the dimension of the heater 68 (refer to FIG. 3) in the width direction.

The support pad 170 includes a pair of grip portions 170a that hold the heater 168 therebetween in the width direction. Lower end portions of the grip portions 170a located closer to the fixing belt 64 are positioned on the same plane as the contact surface 168b of the heater 168.

The internal circumferential surface 64a of the fixing belt 64 is in contact with the heater 168 and the support pad 170 at portions upstream and downstream of the nip portion N in the belt rotation direction. More specifically, at a portion upstream of the nip portion N, the internal circumferential surface 64a is in contact with one end portion of the heater 168 in the width direction (left end portion in the drawing) and a lower end of one of the grip portions 170a. In other words, at a portion upstream of the nip portion N in the belt rotation direction, an accumulation portion (B1 in the drawing) where grease G is held between the heater 168 and the fixing belt 64 to accumulate is generated.

In addition, at a portion downstream of the nip portion N, the internal circumferential surface 64a is in contact with another end portion (right end portion in the drawing) of the heater 168 in the width direction and a lower end of the other one of the grip portions 170a. In other words, at a portion downstream of the nip portion N in the belt rotation direction, an accumulation portion (B2 in the drawing) where grease G is held between the heater 168 and the fixing belt 64 to accumulate is generated.

Operations of Fixing Devices 60 and 160

Before each of the fixing devices 60 and 160 is operated, an application of a voltage to the corresponding one of the heaters 68 and 168 is stopped. In addition, the rotation of the pressing member 82 is stopped.

When a toner image transferred to each recording medium P is to be fixed, a driving force is transmitted to the pressing member 82 from a motor not illustrated, and, as illustrated in FIGS. 3 and 5, the pressing member 82 rotates in the arrow direction in the drawings.

The fixing belt 64 is thus driven by the pressing member 82 to rotate in the arrow direction in the drawings. With the rotation of the fixing belt 64, the grease G applied to the internal circumferential surface 64a of the fixing belt 64 also moves together with the internal circumferential surface 64a. In addition, a voltage is applied from a power source not illustrated to each of the heater 68 and 168. Each of the heaters 68 and 168 thus generates heat, and heats the rotating fixing belt 64.

As illustrated in FIG. 6, in the fixing device 160 according to a comparative example, the accumulation portion B1 at which the grease G accumulates is generated at a portion upstream of the nip portion N in the belt rotation direction. Generation of the accumulation portion B1 reduces the amount of the grease G to be fed between the heater 168 and the fixing belt 64.

In the fixing device 160, the accumulation portion B2 at which the grease G accumulates is also generated at a portion downstream of the nip portion N in the belt rotation direction. Generation of the accumulation portion B2 reduces the amount of the grease G that moves together with the internal circumferential surface 64a in accordance with the rotation of the fixing belt 64. Thus, the amount of the grease G to be fed between the heater 168 and the fixing belt 64 is reduced.

In the fixing device 60 according to the present embodiment, as illustrated in FIG. 3, the heating member 62 and the pressing member 82 are disposed while allowing the internal circumferential surface 64a and a member disposed inside the fixing belt 64 to be in no contact with each other at portions upstream and downstream of the nip portion N.

This structure reduces generation of accumulation portions where the grease G accumulates at portions upstream and downstream of the nip portion N. Thus, the amount of the grease G fed between the heater 68 and the fixing belt 64 is increased compared to that in the fixing device 160 according to a comparative example.

### SUMMARIZATION

In the above embodiment, the grease G has a worked penetration value of lower than or equal to 250, but may have, for example, a worked penetration value of lower than or equal to 250 and higher than or equal to 200.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A fixing device comprising:

a heating member that includes

a tube member that is cylindrical, extends in an axial direction, rotates, and has an internal circumferential surface to which grease is applied, and

a heat generator that extends in the axial direction, that is in contact with the internal circumferential surface, and that generates heat to heat the tube member; and

a pressing member that is disposed to face the heat generator with the tube member interposed therebetween, that forms a nip portion to hold a recording medium between the pressing member and the heating member, and presses the recording medium against the heating member,

wherein the heating member and the pressing member are disposed while allowing the internal circumferential surface and a member disposed inside the tube member to be in no contact with each other at at least one of portions upstream and downstream of the nip portion in a rotation direction of the tube member.

(((2)))

The fixing device according to (((1))),

wherein the grease has a worked penetration value of lower than or equal to 250.

(((3)))

The fixing device according to (((1))) or (((2))),

wherein the internal circumferential surface and the member disposed inside the tube member are in no contact with each other at a portion upstream of the nip portion in the rotation direction of the tube member when the recording medium is held at the nip portion.

(((4)))

The fixing device according to any one of (((1))) to (((3))),

wherein the internal circumferential surface and the member disposed inside the tube member are in no contact with each other at portions upstream and downstream of the nip portion in the rotation direction.

(((5)))

The fixing device according to any one of (((1))) to (((4))),

wherein an edge of the heat generator disposed upstream in the rotation direction of the tube member while the recording medium is held at the nip portion has a center portion in the axial direction recessed further downstream in the rotation direction compared to two end portions of the edge in the axial direction.

(((6)))

The fixing device according to (((5))),

wherein the edge of the heat generator is curved with the center portion in the axial direction recessed further downstream in the rotation direction compared to the two end portions in the axial direction.

(((7)))

An image forming apparatus, comprising:

a forming portion that forms an image on a recording medium; and

the fixing device according to any one of (((1))) to (((6))) that fixes an image formed on a recording medium by the forming portion to the recording medium.

What is claimed is:

1. A fixing device comprising:
a heating member that includes:
a tube member that is cylindrical, extends in an axial direction, rotates, and has an internal circumferential surface to which grease is applied; and
a heat generator that extends in the axial direction, that is in contact with the internal circumferential surface, and that generates heat to heat the tube member; and
a pressing member that is disposed to face the heat generator with the tube member interposed therebetween, that forms a nip portion to hold a recording medium between the pressing member and the heating member, and presses the recording medium against the heating member,
wherein the heating member and the pressing member are disposed while allowing the internal circumferential surface and a member disposed inside the tube member to be in no contact with each other at at least one of portions upstream and downstream of the nip portion in a rotation direction of the tube member.

2. The fixing device according to claim 1,
wherein the grease has a worked penetration value of lower than or equal to 250.

3. The fixing device according to claim 1,
wherein the internal circumferential surface and the member disposed inside the tube member are in no contact with each other at a portion upstream of the nip portion in the rotation direction of the tube member when the recording medium is held at the nip portion.

4. The fixing device according to claim 3,
wherein the internal circumferential surface and the member disposed inside the tube member are in no contact with each other at portions upstream and downstream of the nip portion in the rotation direction.

5. The fixing device according to claim 1,
wherein an edge of the heat generator disposed upstream in the rotation direction of the tube member while the recording medium is held at the nip portion has a center portion in the axial direction recessed further downstream in the rotation direction compared to two end portions of the edge in the axial direction.

6. The fixing device according to claim 5,
wherein the edge of the heat generator is curved with the center portion in the axial direction recessed further downstream in the rotation direction compared to the two end portions in the axial direction.

7. An image forming apparatus, comprising:
a forming portion that forms an image on a recording medium; and
the fixing device according to claim 1 that fixes an image formed on a recording medium by the forming portion to the recording medium.

8. An image forming apparatus, comprising:
a forming portion that forms an image on a recording medium; and
the fixing device according to claim 2 that fixes an image formed on a recording medium by the forming portion to the recording medium.

9. An image forming apparatus, comprising:
a forming portion that forms an image on a recording medium; and
the fixing device according to claim 3 that fixes an image formed on a recording medium by the forming portion to the recording medium.

10. An image forming apparatus, comprising:
a forming portion that forms an image on a recording medium; and
the fixing device according to claim 4 that fixes an image formed on a recording medium by the forming portion to the recording medium.

11. An image forming apparatus, comprising:
a forming portion that forms an image on a recording medium; and
the fixing device according to claim 5 that fixes an image formed on a recording medium by the forming portion to the recording medium.

12. An image forming apparatus, comprising:
a forming portion that forms an image on a recording medium; and
the fixing device according to claim 6 that fixes an image formed on a recording medium by the forming portion to the recording medium.

13. A fixing device comprising:
heating means that includes:
a tube member that is cylindrical, extends in an axial direction, rotates, and has an internal circumferential surface to which grease is applied; and
a heat generator that extends in the axial direction, that is in contact with the internal circumferential surface, and that generates heat to heat the tube member; and
pressing means that is disposed to face the heat generator with the tube member interposed therebetween, the pressing means forming a nip portion to hold a recording medium between the pressing means and the heating means, and pressing the recording medium against the heating means,
wherein the heating means and the pressing means are disposed while allowing the internal circumferential surface and a member disposed inside the tube member to be in no contact with each other at at least one of portions upstream and downstream of the nip portion in a rotation direction of the tube member.
